(19) United States
(12) Patent Application Publication
(10) Pub. No.: US 2004/0173080 A1
(43) Pub. Date: Sep. 9, 2004

(54) MULTI-ANGLE FRET OR NUT FOR GUITAR NECK

(76) Inventors: T. Wilfred Pye, Houma, LA (US); Ruffin Baedron Fox, Rome, GA (US)

Correspondence Address: T. Wilfred Pye, 304 Fairmont Drive, Houma, LA, 70360, US

(21) Appl. No.: 10/376,705

(22) Filed: Mar. 3, 2003

(51) Int. Cl. G10D 3/06

(52) U.S. Cl. 84/314 R

(57) ABSTRACT

A particular fret and nut morphology for tone generation of stepped pitch stringed instruments such as guitar is described. The use of parallel multi-angle frets having a plurality of angles enables better fingerings for cited alternate six string tunings other than provided by common Barre F tuning; E, A, D, G, B, E. Guitars that employ various alternate tunings are shown to be more practical and efficient with the instant multi-angle fret arrangement than the fingerings available with traditional vertically straight frets. The instant embodiment uses positive torque exclusively for an offset region of the multi-angle fret or nut.

### FIELD OF THE INVENTION

This application relates to the field of music, and more specifically to stepped pitch stringed instruments such as guitars crafted for tone generation to a particular fret and nut morphology having a bass portion of the fret offset from another more treble portion of the same fret holding the traditional vertical alignment. The use of parallel multi-angled frets enables better fingerings for certain alternate tunings other than the common Barre F intonation where the strings are tuned to E, A, D, G, B, E (lowest string to highest string). The structure of a multi-angled fret follows a minimum of two angles of travel as the fret spans or traverses the neck or fretboard.

### DESCRIPTION OF THE RELATED ART

The use of vertically straight frets relative to the horizontal flow of strings has long been the accepted method to build stringed instruments. This is because vertically straight frets accommodate themselves well to the use of barre techniques by players to move chords up the neck employing the most prevalent string tuning sequence E, A, D, G, B, E known as Barre F tuning.

For instruments that are not designed to Barre F limitations such as the Ukranian Bandura, serious alterations to vertical fret arrangements are possible. Slanted fret instrument are not designed to be chorded in the efficient manner of guitars. U.S. Pat. No. 3,635,116 by Pelensky shows a modified instrument with bass neck frets slanted no less than 35 degrees from vertical, where the horizontal long neck defines a 90 degree reference to imaginary zero degree frets such as are used on guitars. Even frets as steeply angled as 45% are possible here because the desired utility of these instruments is given from selecting individual pitches in rapid fire mannerisms and the efficient use of a barre finger is not the utility sought.

As with Pelensky, more recently Kolano in U.S. Pat. No. 6,034,310 also cites straight frets expressing no bending or curvature. However, the Kolano fret is slanted in any and all conceivable configurations except vertical.

For inventions where the frets are not straight, the alteration of the shape of frets in the prior art has mainly been as a means of relief to flatten certain fret positions that have tiny positional errors due to the thickness of strings, the concave surface of some fretboards, and the fanning effect as the strings progress away from the nut. This is because perfect intonation when strictly straight and vertical frets are employed has been difficult to attain.

Some recent attention has been devoted to this intonation problem in the prior art including methods altering the transverse vertical perfection of a portion of the frets. This is best studied in U.S. Pat. No. 5,760,320 by Ward et al. but also in U.S. Pat. No. 6,156,962 by Poort who deviates the vertical alignment of the nut rather than the frets for the same problem. Although useful to his intent of correcting the intonation, the cited hot spot irregular alterations by Ward erodes the parallel nature of the frets to each other by disrupting their symmetry, and stretches the boundaries of a process termed locked fret loci which has been used by guitar manufacturers for centuries.

In terms of equal temperament fret design, as one moves along up the neck from fret to fret, on average the distance traversed should express 100 cents of sharping to create the next serial semitone in the scale. A typical fret services six strings, and the position where a given string would contact a given fret is called a fret loci. For any given two frets, if the comparative distance of all six loci from one fret to. the other six loci is an identical distance, then they display the condition termed locked fret loci. This signifies an identical shortening of string length for two different strings of the same open sounding length according to traditional rules of fret design.

In the real world, the actual pitches sounded may not be the usually desired 100 cents of sharping for certain individual hot spot loci, and this is the problem addressed by many inventors such as Ward and Poort. Their inventions are to overcome perceived hot spot intonation deviances usually of a few cents error. The instant invention does not address hot spot correction, as the main instant utility described is to improve fingering ease. The instant deviations to traditional structure of the frets are cited in a manner to maintain locked fret loci at all times. Because the instant invention uses locked fret loci, there will be hot spot errors present as in the common guitar, but correcting these instant hot spots is not the subject of this paper. Rather the subject is the offset manner of the structure of certain portions of the instant frets relative to the non-offset portions of the instant frets.

So ignoring the hot spot problems, and assuming that the rough values achieved by traditional guitar frets are perfect in the real world, the following is true. To compare the vertical perfection of a given fret, any two loci on the fret can be checked for the cent value the thicker string loci flats relative to a “virtual” vertical fret passing through the thinner string loci. If as in the standard model the two loci of a particular one fret servicing two particular strings are in vertical alignment, this alignment condition is termed 0 cents tryst. Deviations such as described by Ward are measured as cents flatted from perfect tryst. Ward calls for a maximum tryst value of 8.333 cents for a particular string loci relative to another string loci of the same first or second fret. This means for a given fret the effected loci will by intent and design flat the pitch up to 8.333 cents from the theoretical value it would have sounded if left at 0 cents tryst. This is a precise measure system, because the physical distance between adjacent frets varies.

### SUMMARY OF THE INVENTION

The use of non-vertical, non-straight frets has been almost totally avoided in the guitar art because it fights the accepted fingerings developed over generations for Barre F tunings. Herein is cited the use of multi-angle frets for other than Barre F. The instant frets use a plurality of angles of travel for the loci, which are spaced along the playing surface of the neck or fretboard. Thus for one fret, a straight line will not pass through all the loci. In every embodiment, the two treblemost loci have a traditional vertical angle of 0 cents tryst. However, at least one of the other loci will be offset.

It is therefore accordingly an object of the present invention to provide a multi-angle fretting arrangement for guitars that will favor certain other musical tuning systems than Barre F tuning. This is done by providing a fretted playing surface for these guitars that either reduces the number of barre chords to a minimum by increasing open chording fingerings for the user, or eases the finger placement when barre chords are employed. Open chords are voicings that have at least one string unfretted.

An arrangement of the pitches expressed by the six open strings of a guitar can be tensioned to the series as calculated from thickest string to thinnest string: major third, minor sixth, fourth, major third, fifth. If the lowest pitch is D, this series completes as F#, D, G, B, E herein termed dropped D major. Another arrangement of the pitches expressed for instance by the six open strings of a guitar can be tensioned to the series as calculated from thickest string to thinnest string: major third, fourth, fourth, fourth, major third. If the first pitch is F, this novel series completes as A, D, G, C, E herein termed Open F. A third quality series has intervals that give B, G, C, G, C, E as the series. Fret structure devised to optimize tunings of this nature is claimed to be novel and useful.

If the Open F tuning is tensioned over the typical straight frets of a traditional guitar, a large number of full six string voicings are somewhat difficult for the human hand to finger. The various fingerings are almost universally improved by the use of multi-angle frets designed to allow a standard 0 cent tryst for the two treble strings, with a smooth progression of elevated tryst as the fret travels underneath the bass strings. Recommended values establish a tryst value of 48 cents for the sixth (bass) string loci relative to the first or second treble string loci of the fret. A straight progression for the four inner tryst values is 12 cents, 12 cents, 12 cents, and 12 cents, which add up to 48 cents tryst. If the offset fret portion is curved in an alternate embodiment, the four inner tryst values will vary (not being identical) but will by laws of nature still add up to a 48 cent tryst value collectively from the sixth to the second loci.

For further clarification not using tryst values, angles and degrees can be used to describe the above cited Open F preferred embodiment. Thus the first two treble loci would express an angle of zero degrees, whereas the third loci relative to the second and first loci would express an angle of twenty-six degrees. The fourth, fifth, and sixth loci would follow the angle expressed by the third loci. Thus the bass portion of the multi-span fret would lie closer to the traditional nut bearing end of the guitar than does the treble portion of the same fret. This is termed positive torque. Negative torque would have the bass portion of the frets further away from the guitar's nut bearing end relative to its treble portion, and is a condition not contemplated by this invention. All instant embodiments use positive torque.

The shape of the first fret is identical to the second, and the third and so forth. These identically shaped frets converge closer and closer to each other on the neck moving away from the nut end, losing about 5.4% of the separation distance at each stage. This shortening of fret separation is a long described art. Locked fret loci is maintained because the strings are the same length and the nut and bridge are shaped to mimic the shape of the parallel frets. Otherwise an undesirable disruption of intonation would appear. In this paper a nut is considered the “zero” fret, because it represents the longest graduated point of a string's vibration farthest away from the bridge end.

### BRIEF DESCRIPTION OF DRAWINGS

FIG. 1 shows the preferred embodiment of multi-angle frets on a guitar neck.

FIG. 2 shows the preferred embodiment of multi-angle frets in close-up.

FIG. 3 shows an alternate embodiment of multi-angle frets in close-up.

FIG. 4 shows another alternate embodiment of multi-angle frets in close-up.

FIG. 5 shows the improvement in fingering ease for a typical Open F chord.

FIG. 6 shows an alternate embodiment using some non-contiguous fret loci.

FIG. 7 shows another alternate embodiment using non-contiguous fret loci.

FIG. 8 shows another alternate embodiment using contiguous fret loci.

### DETAILED DESCRIPTION OF THE INVENTION

FIG. 1 shows a treble string 1 held at tension between tuning keys (not shown) of a headstock 2 passing over nut 3 along fretboard 4 and over soundhole 5 before termination at bridge 6. The first two frets passed over are first fret 7 and second fret 8 and eventually twelfth fret 9. No more than twelve frets are illustrated as more are not required to convey the teaching. For a typical bass guitar, the two bassmost strings would not be depicted.

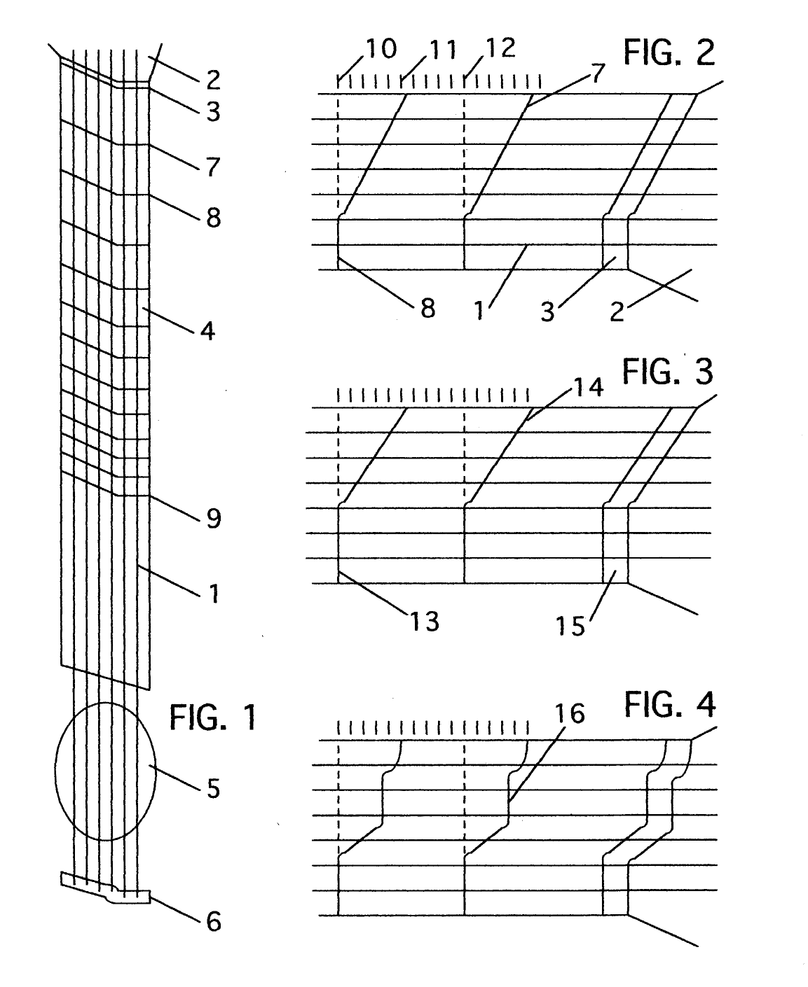

FIG. 2 shows a blowup of the instrument of FIG. 1. Scale markings 10, 11, and 12 illustrate the setback distance of an imaginary vertical fretline directly under marking 10 which also passes through the fret loci where treble string 1 is sounded at fret 8. On this same fret, the horizontal distance measured to the actual fret loci sounding the largest bass string would flat the perceived pitch about 50% of the cent value it would sound on an equal temperament guitar with actual vertical frets. The actual fret loci of this bass string is at a vertical point under marking 11. This is comparative as 50% of the auditory distance to the imaginary vertical fretline directly under marking 12 which also passes through the fret loci where treble string 1 is sounded at fret 7. It should be noted that 50% of the auditory distance is not the same as 50% of the physical distance shown. A flatting of 50 cents tryst is somewhat less than the physical midpoint. The teaching reveals that the six fret loci of fret 7 and the six loci of fret 8 are equidistant for any given string, a condition termed locked fret loci where the six strings are of the same open sounding length. This is only achieved by parallel frets. The facing edge of nut 3 on headstock Z is configured to mimic the path of the frets. If the hashed lines are considered 0 (zero) degrees vertical, relative to this the average string path is therefore 90 degrees. Even if the bassmost four loci of any particular fret could be connected by a curved line (not shown) rather than a straight line (as shown), the mean angle radiating away from the zero degree reference angle servicing the two treble-most loci and the bass-most sixth fret loci would still be about twenty six degrees. Thus curved fret loci are clearly better described by deviations of tryst rather than with degrees.

FIG. 3 shows an alternate embodiment where the bass end of second fret 13 and first fret 14 are still at a 50 cent tryst value relative to the treble end. However the vertical portion of these frets has been lengthened such that the three treblemost loci are all at 0 cent tryst values. Nut 15 is also configured to have its third string slot loci mimic the path of the frets. In this embodiment, the slope of the active bass section of all frets is larger. Thus this angle is widened to about 30 degrees from vertical to maintain a 50 cent tryst value. If a lower cent tryst value were acceptable, the angle could stay at 26 degrees and the string six tryst value would be about 45 cents.

FIG. 4 shows an alternate embodiment where the lowest bass portion of first fret 16 is still at a 50 cent tryst value relative to the two treblemost loci of the fret. As in the embodiment of FIG. 1 the two treblemost loci serve as a 0 cent tryst reference. However to show the variability that can be engineered into the multi-angle frets, the loci under strings three and four are lying on a portion of fret that has been engineered to also run parallel to the treble reference section. Thus this fret has a morphology with four distinct portions. As illustration of the variety that is possible, three portions are shown as straight with the bassmost section curved.

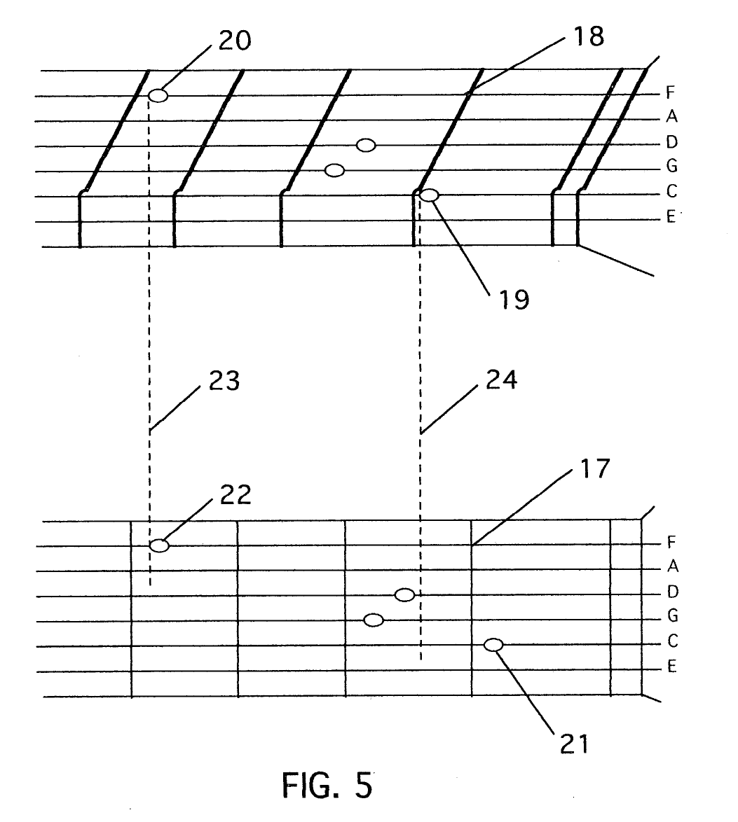

FIG. 5 shows the practical utility of angling a section of the frets from vertical with Open F tuning. The fingering for a voicing for an open A major triad chord is shown. The lower depiction shows a typical prior art guitar fretboard with straight vertical first fret 17 exactly beneath the bass most portion of first fret 18 of the upper guitar. Thus, the bass string loci of both instruments are in vertical alignment. The physical distance on the upper instrument between finger position 19 and finger position 20 is much less than that between finger position 21 and finger position 22 of the lower prior art instrument. This is the difference between a comfortable fingering and a difficult one, and is best seen by utilizing vertical hashed lines 23 and 24 as references. With typical guitars, the eliminated distance from finger position 21 and line 24 is a horizontal separation of over 1.5 centimeters. Due to the cylindrical nature of fingers, the multi-span morphology of the instant frets allows an optimized placement of fingertips recommended to be useful for many chords including the A major triad chord depicted. The first and fifth strings are sounded at the open sounding length.

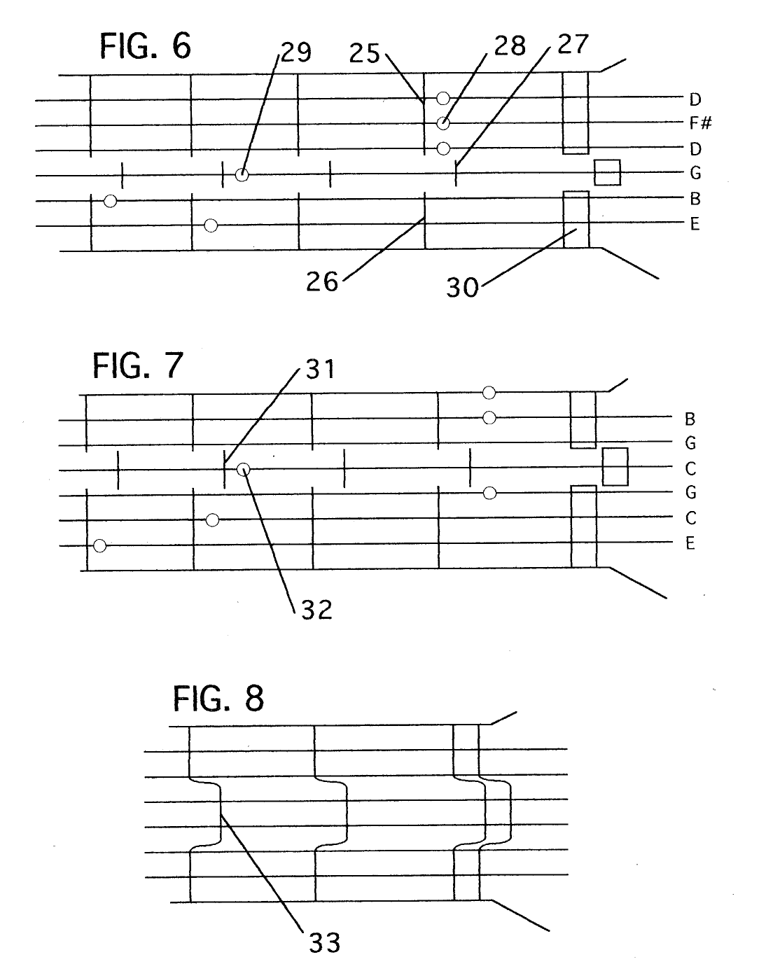

FIG. 6 shows an alternate embodiment where the bass region 25 of a fret is totally separated from the treble region 26. Both regions 25 and 26 are in vertical alignment with each other, and are both non-contiguous with the fret region 27 holding the contact loci for the third most-treble string. The zero fret 30 has a shape mimicking the shape of the other frets. The utility of this structure is evident when the strings are tuned to the low to high series D, F#, D, G, B, E. With an index finger making a barre though position 28 to allow the sounding of three pitches, the middle finger can comfortably set at position 29 while the ring finger and little finger complete a typical major chord. In point of fact, this illustrated fingering would sound a D# major chord. If position 29 was vertical with the ring finger position on the highest string, which it is not, it would reprise the contortion evident with a typical guitar making a typical barre D# formation. The value of this fret structure is the elimination of this awkward fingering for D# major, then E major, then F major, etc. as the barre chord ascends the neck. On a common guitar with vertical straight frets, this chord formation is rarely used because it is so difficult to finger.

FIG. 7 shows an alternate embodiment where the bass and treble regions are non-contiguous with the fret region 31 holding the contact loci for the fourth most-treble string. The utility of this structure is evident when the strings are tuned to the low to high series B, G, C, G, C, E. With the index finger as before making a barre behind the first fret to allow the sounding of three pitches, the middle finger can comfortably be placed at position 32 while the ring finger and little finger complete a major chord. In point of fact, this illustrated fingering would sound a G# major chord. Without the off-set fret loci as indicated, this fingering would be harder to attain.

FIG. 8 shows an alternate embodiment having both of the off-set fret loci of FIGS. 6 and 7, but combined in a way to allow a guitar of this configuration to be tuned to either Open D major or the tuning of FIG. 7. Thus fret region 33 spans two fret loci. For contrast, the entire fret is contiguous.

### SUMMARY

The use of intact frets spanning the vertical regions of the fretboard or neck as in FIGS. 2, 3, 4, and 8 is preferred, but the non-contiguous fretting structure as shown in FIGS. 6, and 7 can be employed. In the same way, the use of one multi-angle contiguous fret in the preferred embodiment of FIG. 2 could be avoided by leaving two non-contiguous frets not in a perfect line with each other but tracking along their own route. Thus each partial fret would service either four or two string loci each. However, for smooth string bending it is advised to leave the two fret portions connected as depicted. The frets in FIGS. 6 and 7 are shown non-contiguous only as an example, since in a preferred design as in FIG. 8 the separated ends exist as one long fret with a bulging hump to provide the desired offset loci.

In all instant embodiments, one or all of the offset loci deliver a desired flatting ability holding a tryst cent value equal to or greater than 10 cents. Also as stated earlier, all embodiments have offset loci placed in a position of positive torque. A plurality of these frets as described in the previous two sentences, and placed on the playing surface of the neck of a stringed instrument define the generalized structure of the instant invention.

Two mechanisms to determine the precise structure of the various preferred and alternate embodiments have been given. One utilizes a tryst value, which is a measurement of flatting in cents relative to a vertical reference. The other mechanism cites a degree of angle relative to a zero degree vertical reference. Using either tryst or slope degree, the various possible combinations are myriad when expressed as deviations to the cited values. The variations are extensive whether using curving frets, straight frets, or disjointed non-contiguous sections of fret designed to service one fret location for one given string. It is the relationship of the six loci to each other that actually define the morphology of the fret. It should be clear that a straight line will not pass through all six loci of the instant multi-angle fret, discounting any curvature of the surface of the fretboard's playing surface.

It is the many diverse open chords allowed that make the Open F tuning outstanding. When a barring technique is used, the sloping or angle of the bass portion of the multi-span frets does not extinguish or hamper a clean sounding of the pitches. The merit of the invention is further confirmed when a plurality of voicings are studied beyond the example chord shown in FIG. 5.

New instruments crafted to the invention are optimal, but modifications are possible for existing prior art fixed pitch fretted instruments. Retrofitting them to empower them to provide the described pitches are possible by refretting the existing fretboards, or refitting them with entirely new fretboards crafted to the invention. Though six strings are cited, four or five stringed instruments can also use the instant invention. The instant drawings will teach this with the bass-most strings removed.

The invention may also be considered as a nut, which in effect is a fret where the loci are in constant contact with the corresponding strings. Thus to call the invention a multi-angle fret or multi-angle nut is entirely appropriate, because the nut should express the same loci orientation as the frets to maintain locked fret loci, which is highly desirable. It has been shown in the illustrations that in these cases the nut must maintain the morphology of the associated fret to provide the proper utility.

The use of parallel frets of like demeanor is recommended together with the common practice of using strings of identical open length. However, non-parallel settings of the multi-angle frets to host unequal string length are contemplated by the inventors as a lesser embodiment. Either way, it is the particular offsetting of the treblemost strings relative to the bassmost string, and the gradualized slope or angle of the fret loci in between which establishes the intent of this instant invention. With strings of different open sounding length, when the frets are fitted along the neck there would by necessity be a need for a slight divergence of angle (relative to each other) for the non-parallel frets to follow acoustical law. For example with a nut-to-bridge distance of 62 centimeters for the other three treble strings, if bass string six is longer by 2 centimeters, string five by 1.5 centimeters, and string four by one centimeter, the shape of the twelfth fret would still be as in FIG. 1. But the sixth loci of the nut would flare out to about a 54 cent tryst value, and each fret would have an intermediate value on the bass loci diminishing down to the desired 48 cent tryst at fret twelve (changes too subtle for the illustration to convey). The test of a given instrument with unequal string length is if the strings are reduced to a common length, the frets as initially given with the test instrument will reveal as corrected values (when flatted by acoustical law to locations sounding the same pitches as before) either a set of tryst values as contemplated by this invention or they will not. In this test the twelfth fret's shape is unaltered.

This invention should not be confined to the embodiments described, as many modifications are possible to one skilled in the art. This paper is intended to cover any variations, uses, or adaptations of the invention following the general principles as described and including such departures that come within common practice for this art and fall within the bounds of the claims appended herein.

We claim:

1. A multi-angle fret or nut for a stringed instrument, said fret or nut of sufficient length to span the width of the playing surface of a guitar neck, with both ends of said guitar neck suitable to be attached to further common structure such as tuning pegs and a bridge whereby six individual strings may be mounted above or removed from above said playing surface of said neck,
said multi-angle fret or nut having six distinct points termed loci suitable for contact with a corresponding one of said six individual strings when said multi-angle fret or nut is mounted along or is part of said playing surface of said guitar neck,
with said multi-angle fret or nut of a composition of matter such as metal sufficiently dense to shorten or stop the sounding length of any of said six strings when said contact exists or is brought about by finger pressure,
where said six loci are identified herein in ascending numerical order from one to six such that loci one serves the outermost treble string and loci six serves the outermost bass string,
with the reference angle of the treblemost portion of said multi-span fret or nut from loci one and continuing beyond loci two at approximately zero degrees,
with the second angle from a point beyond loci two and continuing beyond loci three following a positive torque deflection of twenty-six degrees relative to said reference angle within a variation tolerance of sixteen degrees,
with the third angle from a point beyond loci three and continuing beyond loci four also following a deflection of twenty-six degrees such that said third angle of said multi-span fret or nut follows the same approximate route as said second angle, where the error from said reference angle to said third angle is no more than sixteen degrees from a preferred value of twenty-six degrees,
with the fourth angle from a point beyond said loci four and continuing beyond loci five of a particular degree having a deflection value falling anywhere between thirty-two degrees and said reference of zero degrees,
with the fifth angle from a point beyond loci five and continuing beyond loci six of a particular degree having a deflection value falling anywhere between thirty-two degrees and said reference of zero degrees.

2. A multi-angle fret or nut as in 1, where the error of said reference angle to said third angle is no more than eight degrees from said preferred value.

3. A multi-angle fret or nut as in 1, where the error of said reference angle to said third angle Is no more than four degrees from said preferred value.

4. A multi-angle fret or nut as in 1, where the combined shape of said angle two, said angle three, said angle four, and said angle five is such that a straight line will pass through the associated loci for said combined shape.

5. A multi-angle fret or nut as in 1, where a straight line drawn through said loci two and said loci six will express an angle of approximately twenty-six degrees relative to said reference angle within a tolerance of eight degrees.

6. A multi-angle fret or nut as in 1, with said second angle also maintaining said reference angle of zero degrees,
with said third angle following a twenty-six degree positive deflection relative to said reference angle within a variation tolerance of eight degrees.

7. A fretted neck for a stringed Instrument, said neck bearing a plurality of multi-angle frets of like configuration numbering no less than three,
said neck either engineered as a fretboard suitable for adhesion or attachment to structural reinforcement or engineered as a complete piece serving as both said fretboard and said structural reinforcement,
said neck suitable for hosting at least four strings over said multi-angle frets when said neck is connected at a primary end to means providing a bridge, said bridge enabling the stretching of said strings at a prescribed tension over a nut or zero fret placed at or near a secondary end of said neck,
said strings running along the length of said neck with said strings identified as being either inner or outer strings, whereby the outermost treble string and the outermost bass string flank said inner strings,
said multi-angle frets spaced along said neck in a parallel configuration where for a given fret the locked fret loci servicing said outermost treble string is in vertical alignment with the locked fret loci servicing the next closest inner treble string such that the offset deviation is an approximate 0 cent tryst, whereby this treble portion of said given fret lies roughly at the common angle of 90 degrees relative to the angle of said strings,
said treble portion of said given fret connected to a further section of said given fret, with said further section of positive torque such that said locked fret loci servicing said inner treble string is not vertically in alignment with the corresponding locked fret loci servicing the next adjacent low string with an offset deviation for said further section equal to or greater than 10 cents tryst.

8. A neck as in 7, with the length of said treble portion extended sufficiently to include within said extended length said locked fret loci servicing said inner treble string such that the offset deviation between said inner treble string and said next adjacent low string is also an approximate 0 cent tryst,
said extended treble portion of said given fret connected to said further section of said given fret, with said further section of positive torque such that said locked fret loci servicing said next adjacent low string is not vertically in alignment with the corresponding locked fret loci servicing said outermost bass string with an offset deviation for said further section as described.

9. A neck as in 7, with the section of said given fret containing said loci expressing said 0 cent tryst not contiguous with said further section of said given fret containing said offset loci, whereby said noncontiguous sections together operate as one fret but in fact are divided from each other.

10. A neck as in 7, where the number of said strings is six, with the overall offset deviation value from treble string one loci to bass string six loci of said given fret at a cumulative value between 46 and 50 cents tryst,
where the locked fret loci servicing string two of said given fret is not vertically in alignment with the corresponding locked fret loci servicing string three and expresses an approximate offset deviation at 12 cents tryst,
where for said given fret there is an also an approximate offset deviation at 12 cents tryst between the locked fret loci of string three and string four, between the locked fret loci of string four and string five, and between the locked fret loci of string five and string six,
where approximate offset describes an error of no more than 4 cents tryst.

11. A neck as in 10, where approximate offset describes an error of no more than 2 cents tryst.

12. A neck as in 7, where the number of said strings is six,
with said locked fret loci of said given fret servicing said next adjacent low string in alignment with the corresponding locked fret loci servicing the fourth string having an offset deviation with a value between 0 cents tryst and 13 cents tryst, whereby a straight line passing through the combined loci servicing said next adjacent low string and said fourth string will not pass through the two combined loci servicing said outermost treble string and said next closest inner treble string,
with the fret loci of said given fret servicing the fifth string in alignment with the corresponding locked fret loci servicing the sixth string having an offset deviation with a value between 0 cents tryst and 13 cents tryst.

13. A neck as in 12, whereby a straight line going through the two loci servicing said fifth string and Said sixth string will also pass through one or through both of the two said loci servicing said next adjacent low string and said fourth string.

14. A neck as in 12, whereby a straight line passing through the combined loci servicing said fifth string and said sixth string will not pass through both of the combined loci servicing said outermost treble string and said next closest inner treble string, and will not pass through both of the combined loci servicing said next adjacent low string and said fourth string.

15. A neck as in 12, whereby a straight line going through the two loci servicing said fifth string and said sixth string will also pass through one or through both of the two said loci servicing said outermost treble string and said next closest inner treble string.

16. A fretboard for a stringed instrument together with a plurality of multi-angle frets numbering no less than three embedded in or a part of the playing surface of said fretboard,
said multi-angle frets of identical demeanor aligned at or close to parallel With respect to each other, and with said multi-angle frets having a plurality of either bent and contiguous or divided and non-contiguous sectional portions aligned relative to each other such that for a given fret a straight line will not pass through two points of a first said sectional portion and also pass through an additional two points of a second said sectional portion, whereby either or both of said sectional portions may be gently curved rather than exactly straight,
with said sectional portions of said multi-angle frets positioned relative to a ninety degree center line running parallel with the center line of said fretboard such that said sectional portions are at an angle of slope matching an approximately zero degree vertical angle as referenced to said ninety degree angle of said center line, or at a different angle of slope deviating from said zero degrees by no more than forty-two degrees,
with said first portion for said given fret roughly maintaining said zero degree vertical angle and said second portion of said given fret following a positive angle roughly twenty-six degrees from said zero degree angle within a tolerance of sixteen degrees such that the actual mean angle between said first portion and said second portion is equal to or greater than ten degrees,
said first portion roughly half the length of said second portion.

17. A fretboard as in 16, with said roughly twenty-six degree angle correct within a tolerance of eight degrees such that said actual angle is equal to or greater than eighteen degrees.

18. A fretboard as in 16, with said roughly twenty-six degree angle correct within a tolerance of four degrees such that said actual angle is equal to or greater than twenty-two degrees.

19. A fretboard as in 16, with said first sectional portion of said given fret roughly the same length as the length of said second sectional portion.

20. A fretboard as in 19, with a third sectional portion of said given fret having a position beyond said second sectional portion, with said third portion maintaining an angle of slope of a value either matching the actual angle of slope of either of said first or said second portions, or at an angle of slope greater than one but less than the other.
